(19) United States
(12) Patent Application Publication
(10) Pub. No.: US 2023/0137560 A1
(43) Pub. Date: May 4, 2023

(54) ASSISTANCE SYSTEM AND METHOD FOR GUIDING EXERCISE POSTURES IN LIVE BROADCAST

(71) Applicant: INSTITUTE FOR INFORMATION INDUSTRY, TAIPEI CITY (TW)

(72) Inventors: Keng-Wei LI, TAIPEI CITY (TW); Rong-Sheng WANG, TAIPEI CITY (TW); Te-Lu TSAI, TAIPEI CITY (TW); Hsiao-Chen CHANG, TAIPEI CITY (TW); Shih-Chun CHOU, TAIPEI CITY (TW)

(73) Assignee: INSTITUTE FOR INFORMATION INDUSTRY, TAIPEI CITY (TW)

(21) Appl. No.: 17/535,847

(22) Filed: Nov. 26, 2021

(30) Foreign Application Priority Data
Nov. 4, 2021 (TW) 110141067

(51) Int. Cl. A63B 71/06; H04N 21/2187; H04N 21/4223; G06V 40/20; A63B 24/00

(52) U.S. Cl. CPC A63B 71/0622; H04N 21/2187; H04N 21/4223; G06V 40/23; A63B 24/0062; A63B 2220/05; A63B 2220/806; A63B 2071/0638; A63B 2225/20; A63B 2230/62

(57) ABSTRACT

An assistance system for guiding exercise postures in a live broadcast has a cloud server, at least one first electronic device, and a second electronic device. The cloud server stores a teaching video and multiple templates corresponding to different time segments in the teaching video. Each one of the templates has multiple preset skeleton checking points and multiple movement threshold values respectively corresponding to the multiple preset skeleton checking points. The at least one first electronic device records an image of a first user to generate a skeleton streaming data. In a live broadcast, the at least one first electronic device determines whether the skeleton streaming data is abnormal according to the multiple templates. When abnormal, the at least one first electronic device outputs an abnormality notification. The second electronic device receives the abnormality notification in the live broadcast and displays the abnormality notification and a corresponding message.

### CROSS-REFERENCE TO RELATED APPLICATION(S)

This application claims the priority benefit of TW application serial No. 110141067 filed on Nov. 4, 2021, the entirety of which is hereby incorporated by reference herein and made a part of the specification.

### BACKGROUND OF THE INVENTION

### 1. Field of the Invention

The present invention relates to an assistance system and a method for

guiding exercise postures, more particularly an assistance system and a method for guiding exercise postures in a live broadcast.

### 2. Description of the Related Art

A live broadcast system may be used for multiple purposes. Namely the live broadcast system may be used for remote learnings, business web conferences, or even guidance of exercises. The live broadcast system usually includes a server and multiple electronic devices connected to the server. These electronic devices include an instructor electronic device and multiple student electronic devices. The instructor electronic device is used by an instructor, and the student electronic devices are used by students. Both the instructor electronic device and the student electronic devices should include displaying functions as well as internal or external cameras.

This way, the student electronic devices may shoot student videos and send the student videos to the instructor electronic device. The instructor device receives the student videos and is able to display the student videos of the multiple student electronic devices simultaneously. With reference to FIG. 11, FIG. 11 depicts a perspective view of a display of the instructor electronic device 50. The display includes arrays of the multiple student videos 51. Through the display, the instructor is able to observe how each of the students is exercising through the multiple student videos 51.

However, since the instructor electronic device 50 attempts to display the multiple student videos 51, the display of the instructor electronic device 50 is often equally divided by an amount of the multiple student videos 51. Limited by a size of the display of the instructor electronic device 50, and especially for cases when the instructor electronic device 50 is a smart phone or a tablet computer, a window size of each of the student videos 51 in the display of the instructor electronic device 50 is greatly reduced. As such, the instructor struggles to clearly observe how each of the students is exercising, and thus the instructor also struggles to offer feedback instructions to the students accordingly. As a result, the students may have a poor live exercising experience without proper feedback instructions from the instructor.

### SUMMARY OF THE INVENTION

An objective of the present invention is to provide an assistance system and an assistance method for guiding exercise postures in a live broadcast to overcome the aforementioned problem, wherein in the prior art, limited by a size of the display of an instructor electronic device, a window size of a student video in the display is greatly reduced, and as such an instructor fails to clearly see and guide exercise postures of students through the small student video in the display. The assistance system for guiding exercise postures in a live broadcast of the present invention includes:

a cloud server, storing a teaching video and multiple templates corresponding to different time segments in the teaching video; wherein each one of the templates has multiple preset skeleton checking points and multiple movement threshold values respectively corresponding to the multiple preset skeleton checking points;

at least one first electronic device, connecting the cloud server to download and to play the teaching video; wherein each of the at least one first electronic device includes:

a camera; wherein when the teaching video is being played in a live broadcast, the camera films a first user for generating a first user video;

a skeleton detecting model, generating a skeleton streaming data of the first user according to the first user video; and

a skeleton posture differentiating module; wherein in each of the time segments in the teaching video of the live broadcast, the skeleton posture differentiating module analyzes the skeleton streaming data of the first user according to the preset skeleton checking points and the movement threshold values for obtaining multiple action values of the first user at the preset skeleton checking points, and the skeleton posture differentiating module determines whether an abnormality occurs according to the action values and the movement threshold values; when the skeleton posture differentiating module determines the skeleton streaming data is abnormal, the first electronic device outputs an abnormality notification; and

a second electronic device, connected to the cloud server and the at least one first electronic device, and having an error auto-notifying interface; wherein when the second electronic device receives the abnormality notification in the live broadcast, the second electronic device displays the abnormality notification and a message corresponding to the abnormality notification through the error auto-notifying interface.

The assistance method for guiding exercise postures in a live broadcast of the present invention is used by a cloud server, at least one first electronic device, and a second electronic device. The assistance method for guiding exercise postures in a live broadcast includes:

step(a): storing a teaching video and multiple templates in the cloud server; wherein the multiple templates correspond to different time segments in the teaching video; and wherein each one of the templates has multiple preset skeleton checking points and multiple movement threshold values respectively corresponding to the multiple preset skeleton checking points;

step(b): downloading and playing the teaching video from the cloud server to the at least one first electronic device in a live broadcast, generating a skeleton streaming data of a first user according to a first user video, analyzing the skeleton streaming data of the first user in each of the time segments according to the preset skeleton checking points and the movement threshold values for obtaining multiple action values of the first user at the preset skeleton checking points, and determining whether an abnormality occurs according to the action values and the movement threshold values;

step(c): when the at least one first electronic device determines the skeleton streaming data is abnormal, outputting an abnormality notification from the at least one first electronic device to the second electronic device; and

step(d): when the second electronic device receives the abnormality notification in the live broadcast, displaying the abnormality notification and a message corresponding to the abnormality notification through an error auto-notifying interface of the second electronic device.

The assistance system and method for guiding exercise postures in a live broadcast of the present invention is suitable for online exercise classes. The present invention is particularly applicable for exercises involving proper postures, such as aerobic dancing, aerobics, boxing, and yoga. As an example, each of the at least one first electronic device is used by a student, and the second electronic device is used by an instructor. Through the present invention, the instructor will be able to teach the student in a private online class or a group online class. The present invention is able to determine whether a posture of the student is abnormal. The error auto-notifying interface of the second electronic device is special, because when the present invention determines the posture of the student to be abnormal, the error auto-notifying interface automatically displays the abnormality notification and the message corresponding to the abnormality notification. The instructor would immediately be notified by the abnormality notification and the message through the error auto-notifying interface, and the instructor would instantly recognize the abnormal posture of the student and react accordingly to the student.

### BRIEF DESCRIPTION OF THE DRAWINGS

FIG. 1 is a block diagram of an embodiment of an assistance system for guiding exercise postures in a live broadcast of the present invention.

FIG. 2 is a perspective view of a class information file of the present invention.

FIG. 3 is a perspective view of a teaching video and multiple corresponding time segments of the teaching video of the present invention.

FIG. 4 is a perspective view of multiple preset skeleton checking points of the present invention.

FIG. 5 is a perspective view of continuous body motions within a time segment of the present invention.

FIG. 6 is a perspective view of an error auto-notifying interface of a second electronic device of the present invention simultaneously showing multiple first user videos and the skeleton streaming data.

FIG. 7 is a perspective view of the error auto-notifying interface of the second electronic device of the present invention displaying a message corresponding to an abnormality notification and an abnormality tag on an image.

FIG. 8 is a block diagram of a cloud server and the second electronic device of the present invention.

FIG. 9 is a flow chart of an embodiment of an assistance method for guiding exercise postures in a live broadcast of the present invention.

FIG. 10 is a flow chart of further sub-steps of step S01 shown in FIG. 9.

FIG. 11 is a perspective view of a display of a conventional instructor electronic device.

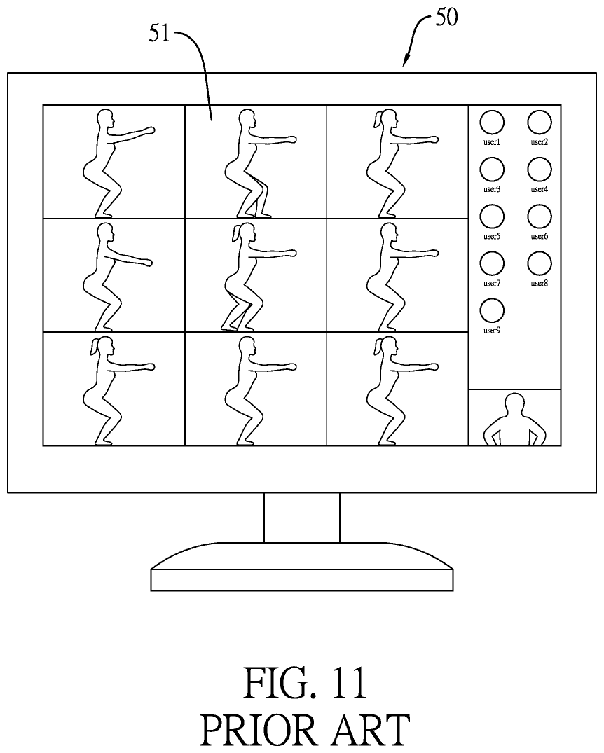

### DETAILED DESCRIPTION OF THE INVENTION

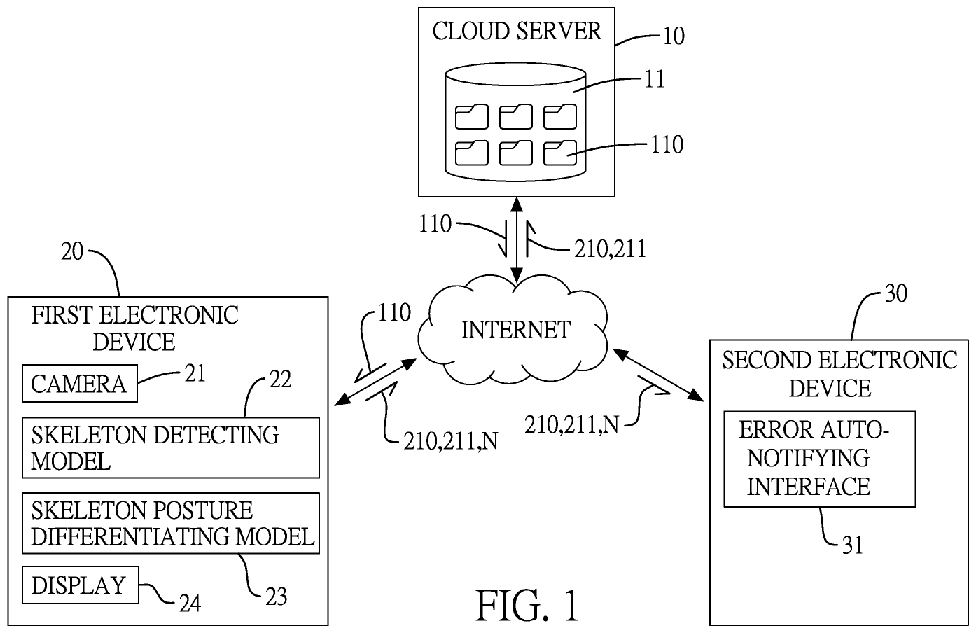

With reference to FIG. 1A, an embodiment of an assistance system for guiding exercise postures in a live broadcast of the present invention includes a cloud server 10, at least one first electronic device 20, and a second electronic device 30. The at least one first electronic device 20 and the second electronic device 30 are connected to the cloud server 10 through internet connection for data transmission.

The cloud server 10 is able to store data and stream live videos. The cloud server 10 includes a computer-readable medium 11 for storing at least one class information file 110. The computer-readable medium 11 may be a hard disk drive (HDD) or a solid-state drive (SSD). In another embodiment, the computer-readable medium 11 is free to be elsewise. Each of the at least one class information file 110 corresponds to an editable file of a live streaming event.

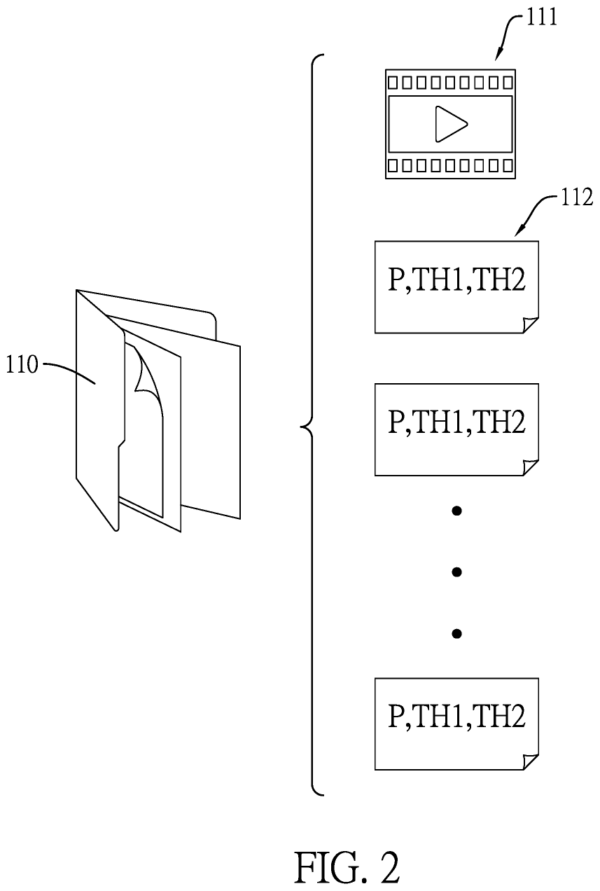

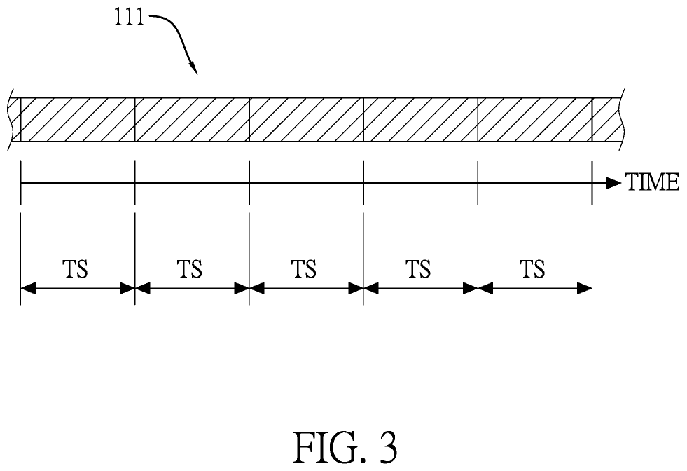

With reference to FIGS. 2 and 3, in the present embodiment, each of the at least one class information file 110 includes a teaching video 111 and multiple templates 112. The teaching video 111 consists of multiple video segments with time segments TS. Each of the time segments TS has a starting time t1 and an ending time t2. Each of the time segments TS also corresponds to a set of continuous body motions, such as raising of a hand, raising of a leg, bending over, etc. In other words, when the cloud server 10 streams the teaching video 111, each set of continuous body motions also is also being accordingly played. The templates 112 correspond to the different time segments TS in the teaching video 111. The templates 112 represent a standard reference information for the sets of continuous body motions. Each one of the templates 112 includes multiple preset skeleton checking points P and multiple movement threshold values TH1 respectively corresponding to the multiple preset skeleton checking points P. Furthermore, each one of the templates 112 also includes multiple abnormal movement checking points and multiple abnormal movement reference conditions TH2 respectively corresponding to the multiple abnormal movement checking points. The abnormal movement checking points may include the preset skeleton checking points P as well as other checking points on the present skeleton. The abnormal movement reference conditions TH2 may be:

having one of the abnormal movement checking points greater than a value at a given time;

having one of the abnormal movement checking points lesser than a value at a given time; or

having one of the abnormal movement checking points between two values at a given time.

The abnormal movement reference conditions TH2 will be explained more in later parts.

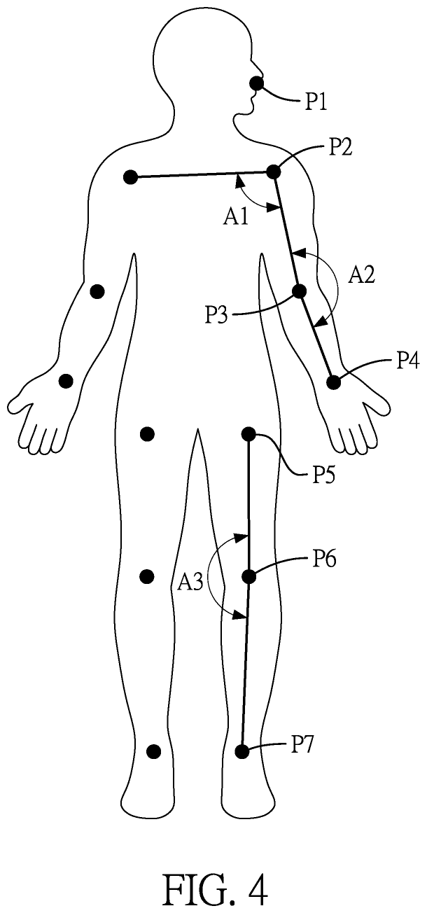

With reference to FIG. 4, the preset skeleton checking points P for example include parts of a human skeletal figure such as a nose P1, shoulders P2, elbows P3, wrists P4, hips P5, knees P6, ankles P7, shoulder angles Al, elbow angles A2, knee angles A3, or any relative distance, horizontal distance, or vertical distance of any two of the preset skeleton checking points P. The preset skeleton checking points P are free to be elsewise in other embodiments. The movement threshold values TH1 are default values for movements. The movement threshold values TH1 are references used to determine whether postures or movement changes are within acceptable ranges. The abnormal movement reference conditions TH2 are also default data for movements. The abnormal movement reference conditions TH2 are references used to determine whether postures or movement changes are abnormal.

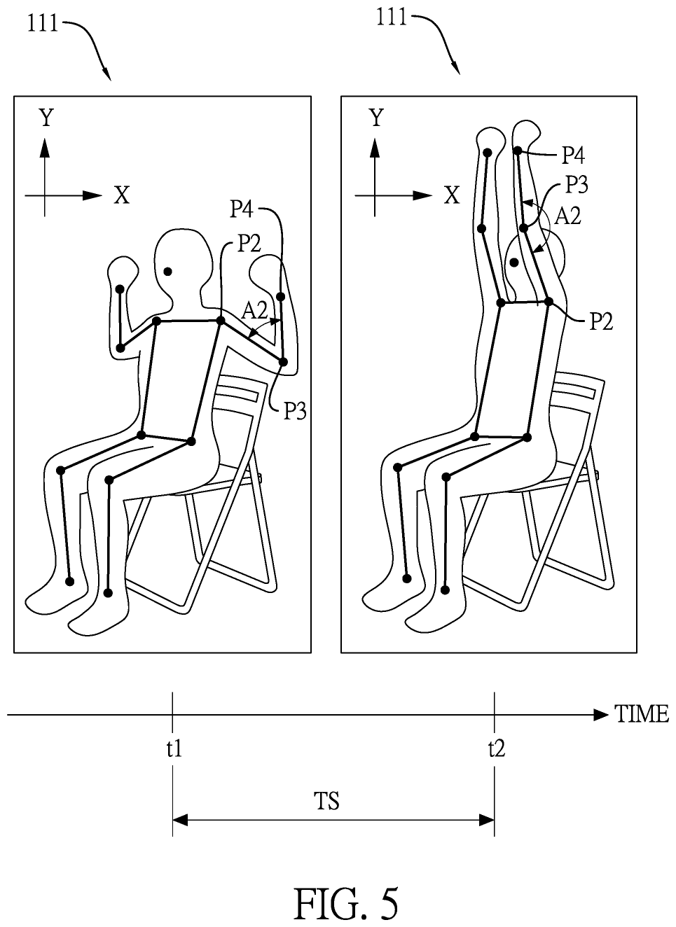

With reference to FIG. 5, for example, within the time segment TS, the set of continuous body motions is raising hand while sitting. The preset skeleton checking points P include the wrists P4 and the elbow angles A2. Each of the wrists P4 corresponds to a first movement threshold value (TH1-1). The first movement threshold value (TH1-1) is a default distance for vertical movements of each of the wrists P4 from the starting time t1 to the ending time t2. Such vertical movements can also be described as movements along a Y axis presented in FIG. 5. Each of the elbow angles A2 corresponds to a second movement threshold value (TH1-2). The second movement threshold value (TH1-2) is a default angle for angular movements of each of the elbow angles A2 from the starting time t1 to the ending time t2. The abnormal movement checking points include vertical distances between the elbows P3 and the shoulders P2, wherein such vertical distances are height differences along the Y axis presented in FIG. 5. In this case, one of the abnormal movement reference conditions TH2 corresponding to the abnormal movement checking points is having vertical distances between the elbows P3 and the shoulders P2 to be less than a given value at the starting time t1.

The at least one first electronic device 20 is used by at least one first user, or in other words, used by at least one student. The first electronic device 20 may be a smart phone, a tablet computer, a personal computer, a laptop, or an internet connectable television. The first electronic device 20 may be elsewise in other embodiments. The first electronic device 20 is connected to the cloud server 10 for data transmission. For example, the first electronic device 20 downloads the class information file 110 from the cloud server 10 and plays the teaching video 111. The first electronic device 20 includes a camera 21, a skeleton detecting model 22, and a skeleton posture differentiating module 23. The camera 21 may be an internal camera embedded in the first electronic device 20, or an external camera. When playing the teaching video 111 in a live broadcast, the camera 21 captures the first user and accordingly generates a first user video 210. Programs of the skeleton detecting model 22 and the skeleton posture differentiating module 23 are stored in a memory or a memory card of the first electronic device 20. Programs of the skeleton detecting model 22 and the skeleton posture differentiating module 23 are executed by a central processing unit (CPU) or a graphics processing unit (GPU) of the first electronic device 20.

The skeleton detecting model 22 is connected to the camera 21, and the skeleton detecting model 22 generates a skeleton streaming data 211 of the first user according to the first user video 210. In the present embodiment, the first user video 210 is two dimensional (2D) for the first electronic device 20. The skeleton detecting model 22 uses a skeleton detection to detect positional coordinates of a nose, shoulders, elbows, wrists, hips, knees, and ankles in the first user video 210, as well as to detect shoulder angles, elbow angles, and knee angles in the first user video 210 to accordingly generate the skeleton streaming data 211. In other words, the skeleton streaming data 211 includes positional coordinates of a nose, shoulders, elbows, wrists, hips, knees, and ankles, as well as shoulder angles, elbow angles, and knee angles in the first user video 210. The skeleton detection technique used by the skeleton detecting model 22 is well known in the related art. The skeleton detecting model 22 may also use other existing techniques to detect the aforementioned parts in the first user video 210. The detection technique used for detecting the aforementioned parts in the first user video 210 is beside the point of the present invention, and therefore further discussion about detection techniques will be omitted.

The skeleton posture differentiating module 23 is connected to the skeleton detecting model 22. In each of the time segments TS of the teaching video 111 of the live broadcast, the skeleton posture differentiating module 23 analyzes the skeleton streaming data 211 of the first user according to the preset skeleton checking points P and the movement threshold values TH1 for obtaining multiple action values of the first user at the preset skeleton checking points P. For the same example as previously mentioned, the preset skeleton checking points P of the corresponding time segment TS include positional coordinates of the elbows P3 and elbow angles A2. The skeleton posture differentiating module 23 obtains the positional coordinates of the elbows P3 and the elbow angles A2 in the skeleton streaming data 211 of the first user. The skeleton posture differentiating module 23 then determines a first action value as vertical positional changes of the positional coordinates of the elbows P3 in the skeleton streaming data 211 from the starting time t1 to the ending time t2 in the time segment TS. The skeleton posture differentiating module 23 also determines a second action value as angle changes of the elbow angles A2 in the skeleton streaming data 211 from the starting time t1 to the ending time t2 in the time segment TS.

With the first and second action values, the skeleton posture differentiating module 23 determines whether an abnormality occurs according to these action values and the movement threshold values TH1. Said abnormality may be a condition that a posture of the first user is abnormal. When the skeleton posture differentiating module 23 determines the abnormality, the first electronic device 20 outputs an abnormality notification N. The data format of the abnormality notification N can be a text or an image. The abnormality notification N notifies the student that the posture of the student is incorrect, for instance, with a text display of “wrist position too low”. Furthermore, when the skeleton posture differentiating module 23 determines the first action value is below the first movement threshold value (TH1-1) or determines the second action value is below the second movement threshold value (TH1-2), the first electronic device 20 outputs the abnormality notification N.

In other embodiments, the skeleton posture differentiating module 23 analyzes the skeleton streaming data 211 of the first user for obtaining multiple values of the first user at the abnormal movement checking points. The skeleton posture differentiating module 23 further determines whether the obtained values match the abnormal movement reference conditions TH2. When determining the obtained values match the abnormal movement reference conditions TH2, the first electronic device 20 also outputs the abnormality notification N. Continuing from the previous example, one of the abnormal movement reference conditions, such as a first abnormal movement reference condition (TH2-1), is that the vertical distances between the elbows P3 and the shoulders P2 should be less than a first abnormal posture value at the starting time t1, and another one of the abnormal movement reference conditions, or such as a second abnormal movement reference condition (TH2-2), is that the elbow angles A2 should be less than a second abnormal posture value at the ending time t2. In other words, the skeleton posture differentiating module 23 not only determines whether the skeleton streaming data 211 of the first user is abnormal at the preset skeleton checking points P, but also determines whether the skeleton streaming data 211 matches the abnormal movement reference conditions TH2 at the abnormal movement checking points. When determining the skeleton streaming data 211 matches the abnormal movement reference conditions TH2 at the abnormal movement checking points, the first electronic device 20 also outputs the abnormality notification N.

The second electronic device 30 is used by a second user, or in other words, an instructor. The second electronic device 30 may be a smart phone, a tablet computer, a personal computer, a laptop, or an internet connectable television. The second electronic device 30 may be elsewise in other embodiments. The second electronic device 30 is connected to the cloud server 10 and the at least one first electronic device 20 for data transmission. The second electronic device 30 includes an error auto-notifying interface 31. The error auto-notifying interface 31 displays the first user video 210 outputted by the first electronic device 20. Due to privacy reasons, some of the students might individually refrain from sharing the first user video 210 to the instructor. In this case, the second electronic device 30 can still receive the skeleton streaming data 211 of the first user from the first electronic device 20.

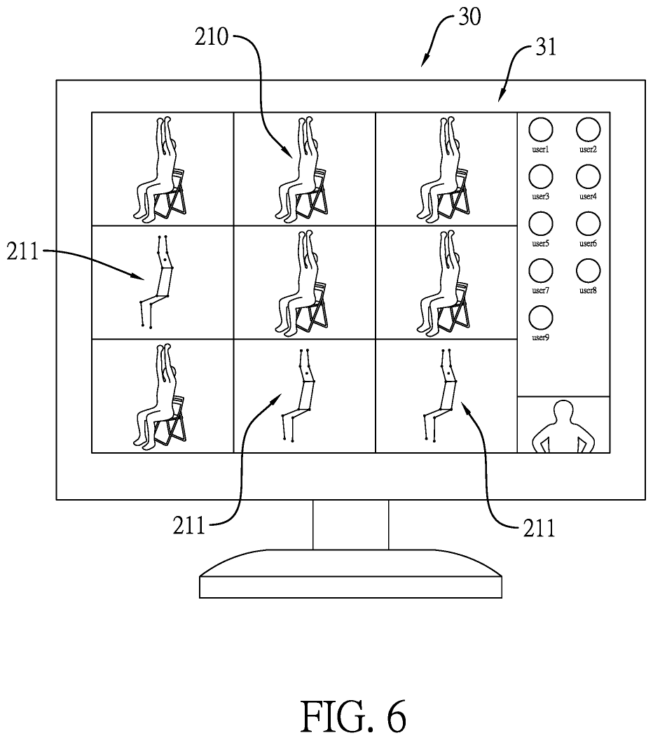

With reference to FIG. 6, the skeleton streaming data 211 of the students is displayed on the error auto-notifying interface 31 for the instructor, and therefore the instructor would be able to monitor the posture of the student with consent to the student's privacy concerns. As a result, for each of the students, the error auto-notifying interface 31 shows the first user video 210 of the student or the skeleton streaming data 211 of the student according to a privacy related choice made by the student through the first electronic device 20.

When the second electronic device 30 receives the abnormality notification N from the first electronic device 20 in the live broadcast, the second electronic device 30 displays the abnormality notification N and a message corresponding to the abnormality notification N through the error auto-notifying interface 31. The message corresponding to the abnormality notification N can be a posture instruction message M, and the data format of the posture instruction message M can be a text or an image. In the present embodiment, the posture instruction message M is used to correct the posture of the student. The posture instruction message M, for instance, can be a text display of “raise the wrist a bit higher, same height with your shoulders”. Furthermore, when the first electronic device 20 outputs the abnormality notification N, a display 24 of the first electronic device 20 also displays the abnormality notification N as well as the corresponding posture instruction message M. This way the student can also be automatically notified about an abnormality of the posture.

When the instructor and the student are having a one-on-one private online class, the at least one first electronic device 20 is just a single electronic device. When the instructor and the students are having a one-on-many group online class, the at least one first electronic device 20 is multiple electronic devices, as in the previously mentioned examples.

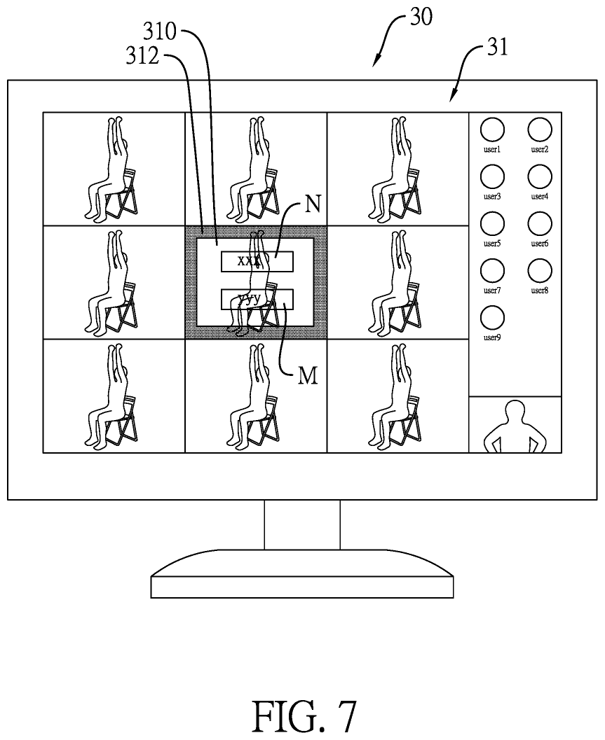

With reference to FIG. 7, the error auto-notifying interface 31 of the second electronic device 30 displays an image 310 corresponding to one of the first electronic devices 20. When the second electronic device 30 receives the abnormality notification N from any one of the first electronic devices 20, the error auto-notifying interface 31 not only displays the abnormality notification N and the corresponding posture instruction message M, but the error auto-notifying interface 31 also displays an abnormality tag 312 on the image 310 corresponding to the first electronic device 20 that has the abnormality notification N. The abnormality tag 312 is a light halo surrounding the image 310. The abnormality tag 312 may be elsewise in other embodiments. The abnormality tag 312 aims to create a highlighting effect for the instructor to clearly identify which of the students has the abnormal posture.

To further improve efficiency of giving out instructions, when the second electronic device 30 receives the abnormality notification N from the first electronic device 20 in the live broadcast, the second electronic device 30 and the first electronic device 20 conduct a voice or video calling with each other. In other words, when the voice or video calling is initiated, both the second electronic device 30 and the first electronic device 20 respectively turn on microphones. Through microphones, audios of the instructor and the student are respectively detected and recorded into audio messages, and the audio messages are mutually exchanged between the first electronic device 20 and the second electronic device 30. This way the instructor is able to give out instructions to the student.

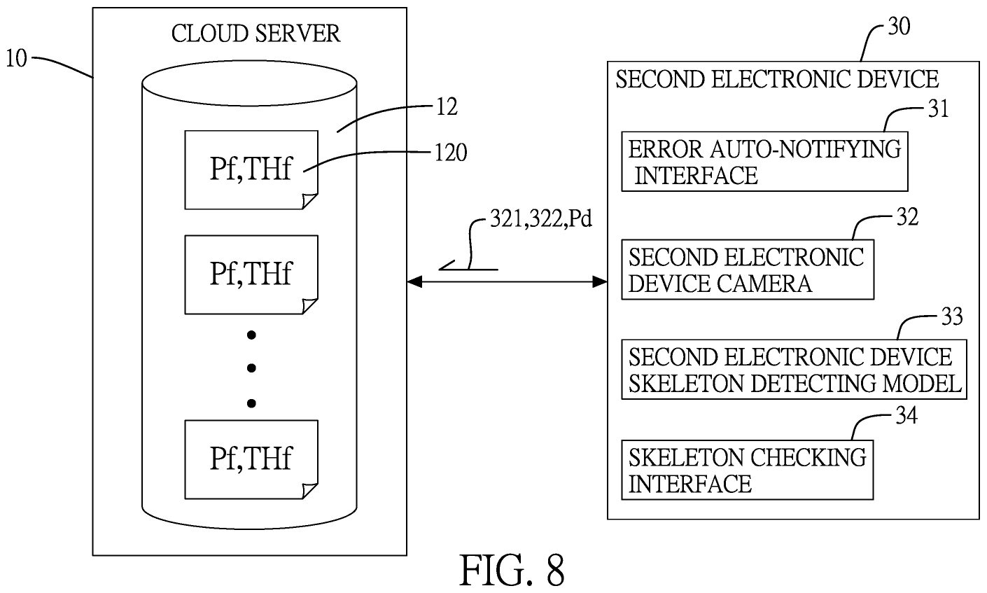

With reference to FIG. 8, the present invention provides the second user a way to fast edit the templates 112 of each of the at least one class information file 110 in the cloud server 10. The computer-readable medium 11 of the cloud server 10 further stores a template database 12. The template database 12 stores multiple base templates 120, and each of the base templates 120 includes multiple base skeleton checking points Pf and multiple base action reference values THf respectively corresponding to the multiple base skeleton checking points Pf. The base skeleton checking points Pf include positional coordinates of a nose, shoulders, elbows, wrists, hips, knees, and ankles, as well as shoulder angles, elbow angles, and knee angles corresponding to the human skeletal figure. The base skeleton checking points Pf may correspond to elsewise in other embodiments. Each of the base action reference values THf is a respective default action value.

The second electronic device 30 includes a second electronic device camera 32, a second electronic device skeleton detecting model 33, and a skeleton checking interface 34. The second electronic device camera 32 may be an internal camera embedded in the second electronic device 30, or an external camera. The second electronic device camera 32 captures the second user and accordingly generates a workout video 321 of the second user. The workout video 321 is then sent to the cloud server 10 as the teaching video 111. Programs of the second electronic device skeleton detecting model 33 are stored in a memory or a memory card of the second electronic device 30. Programs of the second electronic device skeleton detecting model 33 are also executed by a CPU or a GPU. The second electronic device skeleton detecting model 33 is electrically connected to the second electronic device camera 32. The second electronic device skeleton detecting model 33 generates a second user skeleton streaming data 322 according to the workout video 321 of the second user. Further descriptions regarding the second user skeleton streaming data 322 are analogous to further descriptions regarding the skeleton detecting model 22 of the first electronic device 20. Therefore, further descriptions regarding the second user skeleton streaming data 322 are hereby omitted.

The skeleton checking interface 34 is a graphical user interface (GUI) displayable for the second electronic device 30. The skeleton checking interface 34 is free to be elsewise in other embodiments. The skeleton checking interface 34 displays the second user skeleton streaming data 322. According to a first user command, the skeleton checking interface 34 sets multiple appointed skeleton checking points Pd in the different time segments TS of the second user skeleton streaming data 322. The skeleton checking interface 34 then sends the multiple appointed skeleton checking points Pd to the cloud server 10. The first user command is a command generated by the second user via a touch screen of the second electronic device 30, or via a keyboard or a mouse connected to the second electronic device 30. As such, in each of the time segments TS, when the cloud server 10 determines the appointed skeleton checking points Pd match the base skeleton checking points Pf in one of the base templates 120, the cloud server 10 sets the base templates 120 as the templates 112 of the class information file 110, sets the base skeleton checking points Pf as the preset skeleton checking points P of the class information file 110, and sets the base action reference values THE as the movement threshold values TH1 of the class information file 110. This way the second user only needs to choose the appointed skeleton checking points Pd through the skeleton checking interface 34 for the cloud server 10 to automatically generate actual class contents for each of the templates 112 of the class information file 110. Since the second user is saved from personally editing the preset skeleton checking points P and the movement threshold values TH1 of the templates 112, the present invention brings convenience to the second user for hosting the online class.

On the other hand, the cloud server 10 also determines whether the appointed skeleton checking points Pd received by the second electronic device 30 match the base skeleton checking points Pf of the base templates 120 in any of the given time segments TS. When a mismatch is determined, the cloud server 10 then sets the appointed skeleton checking points Pd as the base skeleton checking points Pf in a new base template, and sets the base action reference values THE in the new base template according to a second user command. This way when the instructor develops a new set of continuous body motions, the cloud server 10 will be able to correspondingly create the new base template. As a result, the class information file 110 will be rich with the new base template in one of the base templates 120 for future uses.

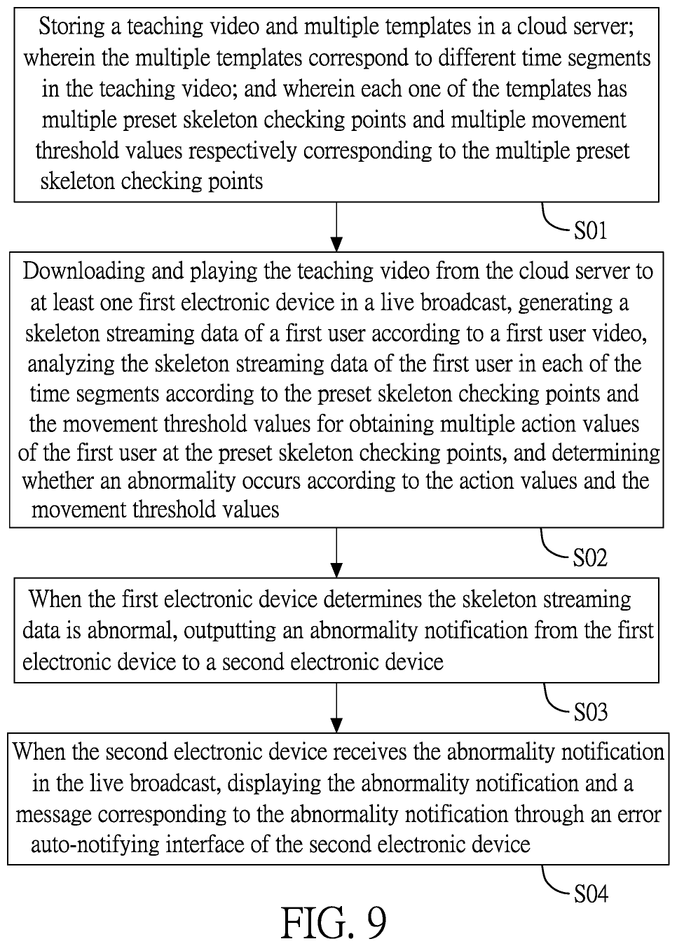

With reference to FIG. 9, as a conclusion to the aforementioned descriptions, FIG. 9 depicts an embodiment of an assistance method for guiding exercise postures in a live broadcast of the present invention. The embodiment includes the following steps:

Step S01: storing a teaching video 111 and multiple templates 112 in a cloud server 10; wherein the multiple templates 112 correspond to different time segments TS in the teaching video 111; and wherein each one of the templates 112 has multiple preset skeleton checking points P and multiple movement threshold values TH1 respectively corresponding to the multiple preset skeleton checking points P.

Step S02: downloading and playing the teaching video 111 from the cloud server 10 to at least one first electronic device 20 in a live broadcast, generating a skeleton streaming data 211 of a first user according to a first user video 210, analyzing the skeleton streaming data 211 of the first user in each of the time segments TS according to the preset skeleton checking points P and the movement threshold values TH1 for obtaining multiple action values of the first user at the preset skeleton checking points P, and determining whether an abnormality occurs according to the action values and the movement threshold values TH1.

Step S03: when the first electronic device 20 determines the skeleton streaming data 211 is abnormal, outputting an abnormality notification N from the first electronic device 20 to a second electronic device 30; and

Step S04: when the second electronic device 30 receives the abnormality notification N in the live broadcast, displaying the abnormality notification N and a message corresponding to the abnormality notification N through an error auto-notifying interface 31 of the second electronic device 30.

In some embodiments, the cloud server 10 includes a template database 12. The template database 12 stores multiple base templates 120, and each of the base templates 120 includes multiple base skeleton checking points Pf and multiple base action reference values THE respectively corresponding to the multiple base skeleton checking points Pf.

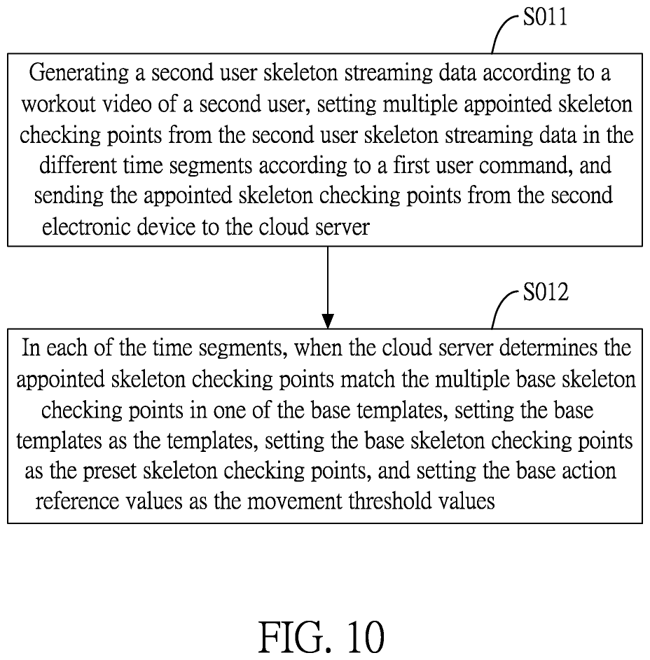

With reference to FIG. 10, step S01 includes further sub-steps:

Step S011: generating a second user skeleton streaming data 322 according to a workout video 321 of a second user, setting multiple appointed skeleton checking points Pd from the second user skeleton streaming data 322 in the different time segments TS according to a first user command, and sending the appointed skeleton checking points Pd from the second electronic device 30 to the cloud server 10.

Step S012: in each of the time segments TS, when the cloud server 10 determines the appointed skeleton checking points Pd match the multiple base skeleton checking points Pf in one of the base templates 120, setting the base templates 120 as the templates 112, setting the base skeleton checking points Pf as the preset skeleton checking points P, and setting the base action reference values THf as the movement threshold values TH1.

In some embodiments, for step S012, and for each of the time segments TS, when determining the appointed skeleton checking points Pd mismatch the multiple base skeleton checking points Pf in the base templates 120, the cloud server 10 sets the appointed skeleton checking points Pd as the base skeleton checking points Pf in a new base template, and sets the base action reference values THf in the new base template according to a second user command. The second user command is also a command generated by the second user via a touch screen of the second electronic device 30, or via a keyboard or a mouse connected to the second electronic device 30.

In some embodiments, each of the templates 112 includes a posture instruction message M. In step S03, when the first electronic device 20 outputs the abnormality notification N, display the abnormality notification N and the posture instruction message M corresponding to the abnormality notification N through a display 24 of the first electronic device 20.

In some embodiments and in step S02, when the at least one first electronic device 20 is multiple electronic devices, images 310 of the first electronic devices 20 are displayed through the error auto-notifying interface 31 of the second electronic device 30. In step S04, when the second electronic device 30 receives the abnormality notification N from any one of the first electronic devices 20, a tag 312 on the image 310 of each of the first electronic devices 20 corresponding to the abnormality notification N is displayed through the error auto-notifying interface 31.

In some embodiments, each one of the templates 112 includes multiple abnormal movement checking points and multiple abnormal movement reference conditions TH2 respectively corresponding to the multiple abnormal movement checking points. In step S03, when determining the obtained values of the skeleton streaming data 211 at the abnormal movement checking points in each of the time segments TS match the abnormal movement reference conditions TH2, the first electronic device 20 outputs the abnormality notification N.

In some embodiments and in step S04, after receiving the skeleton streaming data 211 of the first user from the at least one first electronic device 20 to the second electronic device 30, the second electronic device 30 displays the skeleton streaming data 211 of the first user through the error auto-notifying interface 31 of the second electronic device 30.

In some embodiments and in step S04, when receiving the abnormal notification N in the live broadcast, the second electronic device 30 conducts a voice or video calling between the second electronic device 30 and the first electronic device 20.

In conclusion, the present invention has the following advantages:

1. The present invention is suitable for a platform of online classes of exercise instructions and for a service application (APP). Especially, the present invention is suitable for online exercise streams, for exercises such as aerobic dancing, boxing, aerobics, yoga, etc.

2. When the instructor needs to have a one-to-many group class, the present invention provides the special error auto-notifying interface 31, wherein when one of the students has an abnormal posture, situation relating to the abnormal posture will be automatically displayed through the error auto-notifying interface 31 for the instructor. Compared to the prior art, rather than having small arrays of student footages for the instructor, the present invention notifies the instructor automatically regarding the abnormal posture of the student, ensuring the instructor is able to immediately identify and address on the abnormal posture of the student.

3. If the instructor wants to frequently update online classes in the broadcast, the present invention provides a convenient tool, wherein once the workout video 321 is recorded by the instructor and uploaded to the cloud server 10, the appointed skeleton checking points Pd for the class can be immediately configured through the skeleton checking interface 34. This way in every online class, each student can know whether his/her body postures are abnormal through his/her smart phone.

4. When the student refuses to share the first user video 210, the instructor will still be able to receive the potential abnormality notification N and the corresponding posture instruction message M through the second electronic device 30.

The above detail only some embodiments of the present invention, rather than imposing any forms of limitations toward the present invention. Any professionals in related field of the present invention may make use of the aforementioned technical information for equivalent changes. However, without deviating away from the technical information of the present invention, all of the equivalent changes are all encompassed by what is claimed for the present invention.

What is claimed is:

1. An assistance system for guiding exercise postures in a live broadcast, comprising:
a cloud server, storing a teaching video and multiple templates corresponding to different time segments in the teaching video, wherein each one of the templates has multiple preset skeleton checking points and multiple movement threshold values respectively corresponding to the multiple preset skeleton checking points;
at least one first electronic device, connecting the cloud server to download and to play the teaching video, wherein each of the at least one first electronic device comprises:
a camera, wherein when the teaching video is being played in a live broadcast, the camera films a first user for generating a first user video;
a skeleton detecting model, generating a skeleton streaming data of the first user according to the first user video; and
a skeleton posture differentiating module, wherein in each of the time segments in the teaching video of the live broadcast, the skeleton posture differentiating module analyzes the skeleton streaming data of the first user according to the preset skeleton checking points and the movement threshold values for obtaining multiple action values of the first user at the preset skeleton checking points, and the skeleton posture differentiating module determines whether it is abnormal according to the action values and the movement threshold values, wherein when the skeleton posture differentiating module determines it is abnormal, the first electronic device outputs an abnormality notification; and
a second electronic device, connected to the cloud server and the at least one first electronic device, and having an error auto-notifying interface, wherein when the second electronic device receives the abnormality notification in the live broadcast, the second electronic device displays the abnormality notification and a message corresponding to the abnormality notification through the error auto-notifying interface.

2. The assistance system as claimed in claim 1, wherein:
the cloud server comprises a template database, the template database stores multiple base templates, each of the base templates comprises multiple base skeleton checking points and multiple base action reference values respectively corresponding to the multiple base skeleton checking points;
the second electronic device comprises:
a second electronic device camera, generating a workout video of a second user;
a second electronic device skeleton detecting model, generating a second user skeleton streaming data according to the workout video of the second user; and
a skeleton checking interface, setting multiple appointed skeleton checking points from the second user skeleton streaming data in the different time segments according to a first user command, and sending the appointed skeleton checking points to the cloud server;
in each of the time segments, when the cloud server determines the appointed skeleton checking points match the base skeleton checking points in one of the base templates, the cloud server sets the base templates as the templates, sets the base skeleton checking points as the preset skeleton checking points, and sets the base action reference values as the movement threshold values.

3. The assistance system as claimed in claim 2, wherein:
in each of the time segments, when the cloud server determines the appointed skeleton checking points mismatch the base skeleton checking points in the base templates, the cloud server sets the appointed skeleton checking points as the base skeleton checking points in a new base template, and sets the base action reference values in the new base template according to a second user command.

4. The assistance system as claimed in claim 2, wherein:
each of the templates further comprises a posture instruction message;
when the first electronic device outputs the abnormal notification, the abnormal notification and the corresponding posture instruction message are displayed through a display of the first electronic device.

5. The assistance system as claimed in claim 1, wherein:
the at least one first electronic device is multiple electronic devices, the error auto-notifying interface displays images of the first electronic devices;
when the second electronic device receives the abnormal notification from any one of the first electronic devices, a tag is displayed on the image of the first electronic device corresponding to the abnormality notification on the error auto-notifying interface.

6. The assistance system as claimed in claim 1, wherein:
each of the templates comprises multiple abnormal movement checking points and multiple abnormal movement reference conditions respectively corresponding to the multiple abnormal movement checking points;
when the at least one first electronic device determines obtained values of the skeleton streaming data at the abnormal movement checking points in each of the time segments match the abnormal movement reference conditions, the at least one first electronic device outputs the abnormality notification.

7. The assistance system as claimed in claim 1, wherein:
the second electronic device receives the skeleton streaming data of the first user from the at least one first electronic device, and displays the skeleton streaming data of the first user through the error auto-notifying interface.

8. The assistance system as claimed in claim 1, wherein:
when the second electronic device receives the abnormal notification in the live broadcast, the second electronic device and the at least one first electronic device conduct a voice or video calling with each other.

9. An assistance method for guiding exercise postures in a live broadcast, used by a cloud server, at least one first electronic device, and a second electronic device, comprising:
step (a): storing a teaching video and multiple templates in the cloud server, wherein the multiple templates correspond to different time segments in the teaching video, and wherein each one of the templates has multiple preset skeleton checking points and multiple movement threshold values respectively corresponding to the multiple preset skeleton checking points;
step (b): downloading and playing the teaching video from the cloud server to the at least one first electronic device in a live broadcast, generating a skeleton streaming data of a first user according to a first user video, analyzing the skeleton streaming data of the first user in each of the time segments according to the preset skeleton checking points and the movement threshold values for obtaining multiple action values of the first user at the preset skeleton checking points, and determining whether an abnormality occurs according to the action values and the movement threshold values;
step (c): when the at least one first electronic device determines the skeleton streaming data is abnormal, outputting an abnormality notification from the at least one first electronic device to the second electronic device; and
step (d): when the second electronic device receives the abnormality notification in the live broadcast, displaying the abnormality notification and a message corresponding to the abnormality notification through an error auto-notifying interface of the second electronic device.

10. The assistance method as claimed in claim 9, wherein:
the cloud server comprises a template database, the template database stores multiple base templates, each of the base templates comprises multiple base skeleton checking points and multiple base action reference values respectively corresponding to the multiple base skeleton checking points;
step (a) further comprises:
step (a1): generating a second user skeleton streaming data according to a workout video of a second user, setting multiple appointed skeleton checking points from the second user skeleton streaming data in the different time segments according to a first user command, and sending the appointed skeleton checking points from the second electronic device to the cloud server;
step (a2): in each of the time segments, when the cloud server determines the appointed skeleton checking points match the multiple base skeleton checking points in one of the base templates, setting the base templates as the templates, setting the base skeleton checking points as the preset skeleton checking points, and setting the base action reference values as the movement threshold values.

11. The assistance method as claimed in claim 10, wherein for step (a2):
in each of the time segments, when the cloud server determines the appointed skeleton checking points mismatch the multiple base skeleton checking points in the base templates, setting the appointed skeleton checking points as the base skeleton checking points in a new base template, and setting the base action reference values in the new base template according to a second user command.

12. The assistance method as claimed in claim 10, wherein:
each of the templates comprises a posture instruction message;
for step (c), when the first electronic device outputs the abnormal notification, displaying the abnormal notification and the corresponding posture instruction message through a display of the first electronic device.

13. The assistance method as claimed in claim 9, wherein:
for step (b), when the at least one first electronic device is multiple electronic devices, respectively displaying images of the first electronic devices through the error auto-notifying interface;
for step (d), when the second electronic device receives the abnormal notification from any one of the first electronic devices, displaying a tag on the image of said one of the first electronic devices corresponding to the abnormality notification on the error auto-notifying interface.

14. The assistance method as claimed in claim 9, wherein:
each of the templates comprises multiple abnormal movement checking points and multiple abnormal movement reference conditions respectively corresponding to the multiple abnormal movement checking points;
when determining obtained values of the skeleton streaming data at the abnormal movement checking points in each of the time segments match the abnormal movement reference conditions, the at least one first electronic device outputs the abnormality notification.

15. The assistance method as claimed in claim 9, wherein for step (d):
receiving the skeleton streaming data of the first user for the second electronic device from the at least one first electronic device, and displaying the skeleton streaming data of the first user through the error auto-notifying interface.

16. The assistance method as claimed in claim 9, wherein for step (d):
when the second electronic device receives the abnormal notification in the live broadcast, conducting a voice or video calling between the second electronic device and the at least one first electronic device.
